(19) United States
(12) Patent Application Publication
(10) Pub. No.: US 2002/0054029 A1
(43) Pub. Date: May 9, 2002

(54) Interactive display system

(76) Inventors: John Thomas Glancy, Canyon Country, CA (US); Jeffrey Spencer Glancy, Canyon Country, CA (US); Michael Blair Glancy, Palmdale, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 09/997,422

(22) Filed: Nov. 28, 2001

Related U.S. Application Data
(60) Provisional application No. 60/250,179, filed on Nov. 28, 2000.

(51) Int. Cl. G09G 5/00

(52) U.S. Cl. 345/173

(57) ABSTRACT

A method for providing information via an interactive display system includes activating the system when inputting a command by touching an interactive display screen. The command is transmitted to a remote client computer via a KVM extender. The client computer processes the input command and generates and sends a data request to a server computer associated with the database via a computer network. The database is searched for data corresponding to the data request, and any dynamic data is compiled and formatted into a template-based dynamic web page. Any dynamic graphic layouts are also incorporated. The retrieved data corresponding to the data request is transmitted from the client computer to the interactive display screen via the KVM extender, where it is displayed in a user-friendly web page format. The system can be easily updated by modifying data using customized database forms accessed through the server computer.

### RELATED APPLICATION

This application claims priority of U.S. Provisional Application No. 60/250,179 filed Nov. 28, 2000.

### BACKGROUND OF THE INVENTION

The present invention generally relates to computer-driven interactive display systems. More particularly, the present invention relates to an interactive touch screen display system that enables users to navigate various dynamic display screens by touch to access information while being readily modifiable and upgradeable.

There are various types of means of providing and disseminating information with different disadvantages with each. Marquees, poster boards, brochures, catalogs, etc. can be qualified as a non-multimedia display. While these typically printed materials are simple, portable and readily available, they all have the disadvantage of not being permanent, not capable of being updated and are not as visually stimulating as video, audio and computer related graphics.

Other means of conveying information includes the use of a human interface such as a host, receptionists, concierge, sales associate, etc. While having the advantage of human to human contact with accompanying emotion and non-verbal communication, it has been found that such human interfaces can be intimidating. Also, typically only one host or receptionist is available at any given time and for only short periods of the day. The use of human hosts, receptionists, etc. has also been found to be quite expensive and oftentimes incapable of answering many of the questions presented due to human memory limitations.

Another alternative in the past for conveying information has been the use of audio announcements, e.g. paging systems, looping audio files, etc. The advantages of such audio systems is that they are relatively inexpensive, have the ability to isolate a zone or area in which such audio announcements are intended to be conveyed, and can be widely distributed. However, such audio announcements are non-interactive, do not meet the presently demanded information, are not capable of real time updates, and require time intensive set ups and modifications.

With the advent of electronics and computers, many companies and groups desiring to convey information to an interested or purchasing public have resorted to video monitors using text messaging systems, looping video, etc. Such monitoring systems have the advantages of multiple location distribution and the use of common and familiar devices. However, such video monitors are static and not real time updatable, are non-interactive, do not meet the current demand for information, and are relatively time intensive when updating and inputting data.

With the increase of computer functionality and the advance in quality of display devices, the use of computers for multimedia applications has flourished. Particularly, the use of computers and connected displays for communication and interaction in “self-service kiosk” type architecture and configuration is gaining widespread use. Kiosks range in function from ATM machines, to POS (point of sale) systems, to virtual receptionists and museums displays. Many of these kiosks replicate the same function, i.e. a box-type of enclosure housing a computer, monitor, and other peripheral devices. Each of these kiosks attempts to establish communication between computer and a human user.

Such kiosks have the advantages of non-recurring labor costs and the capability for dynamic displays. However, such kiosks are often large in size as a computer server is co-located with the display screen. Thus, a fairly large amount of area, or a large footprint is required although the display screen may be quite small. Also, such kiosks have in the past been fairly limited in the amount and type of information provided. Even if the user interface was found to be “friendly”, the information provided by such kiosks was often static in nature, that is limited in scope and not dynamic to meet the needs of the inquiring user. Additionally, such kiosks in the past have required a highly technical individual to update the system information, at times even requiring reprogramming of various display and/or database files to present new information.

Accordingly, there is a continuing need for a computer-based display system having all of the advantages of the prior kiosk-based devices, yet occupying relatively little floor space, being esthetically pleasing, and easy to update in real time relatively by non-technical personnel so as to limit maintenance and update costs. The present invention fulfills these needs and provides other related advantages.

### SUMMARY OF THE INVENTION

The present invention resides in an interactive display system incorporating KVM (Keyboard, Video, Mouse, Serial) extenders so as to enable a touch activated display screen to be positioned a distance, often several hundred feet, from a client computer that manages the information displayed on the display screen. Use of the KVM extenders and switches in the hardware architecture of the system also enables the owner of the system to make modifications to information in a database associated with the system from various computers using a single monitor. Customized database forms and template-based dynamic web page creation software enable non-technical personnel to update the data in the database in real time.

The method for providing information via the interactive display system generally comprises the steps of creating data and saving the data in a database. The created data may be modified using a customized database form, accessed through a server computer associated with the database and saving the newly generated data in the database.

Typically, a video collage is displayed on an interactive display screen, inviting a user to step up to the screen and interact with the system. The system is activated when inputting a command by touching the interactive display screen. The command is determined by plotting the location touched on the interactive display screen and correlating this location with a displayed link.

The command is transmitted to a remote client computer via a KVM extender having a receiver coupled to the interactive touch screen and a transmitter coupled to the client computer. A data request is created and the database is searched for data corresponding to the data request. Although the client computer can either house the database, or act as a server and connect to the database via a computer network, typically the system includes a server computer which is interconnected to the client computer via a computer network for searching the database. The client computer processes the input command and generates and sends a data request to the server computer via the computer network. It is first determined if the data requested is dynamic. If the request is for static information, the requested formatted page is simply returned for display. The database is then searched for data corresponding to the data request. Dynamic data is compiled and formatted into a template-based dynamic web page. If a graphic layout is dynamic, previously created dynamic multimedia and graphic files are incorporated into the dynamic graphic layout.

The retrieved data corresponding to the data request is then transmitted from the client computer to the interactive display screen via the KVM extender. This data, properly formatted and compiled, is displayed on the interactive screen display in a web page format. After a predefined period of interactive display screen activity, the video collage is then redisplayed to once again invite a user to activate the system to retrieve information. The invention contemplates interfacing multiple interactive display screens and client computers with a single server computer so that information can be conveyed in multiple locations simultaneously.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a schematic diagram of hardware components comprising the interactive display system of the present invention;

FIG. 2 is a flow diagram illustrating flow of data through various components of the system of the present invention;

FIG. 3 depicts an exemplary screen displayed in accordance with the present invention;

FIG. 4 is a flow chart outlining the flow of data and various logic processes in accordance with the present invention;

FIG. 5 is a schematic diagram illustrating steps taken in interfacing with and modifying data within a database of the present invention; and

FIG. 6 depicts a screen interface in the form of a customized database form modifiable by an owner of the system.

### DETAILED DESCRIPTION OF THE PREFERRED EMBODIMENT

As shown in the accompanying drawings for purposes of illustration, the present invention resides in a computer-based interactive display system, generally referred to by the reference number 10. The system 10 is in the form of a multimedia kiosk display, and incorporates many features which are unique and provides benefits absent in the prior art.

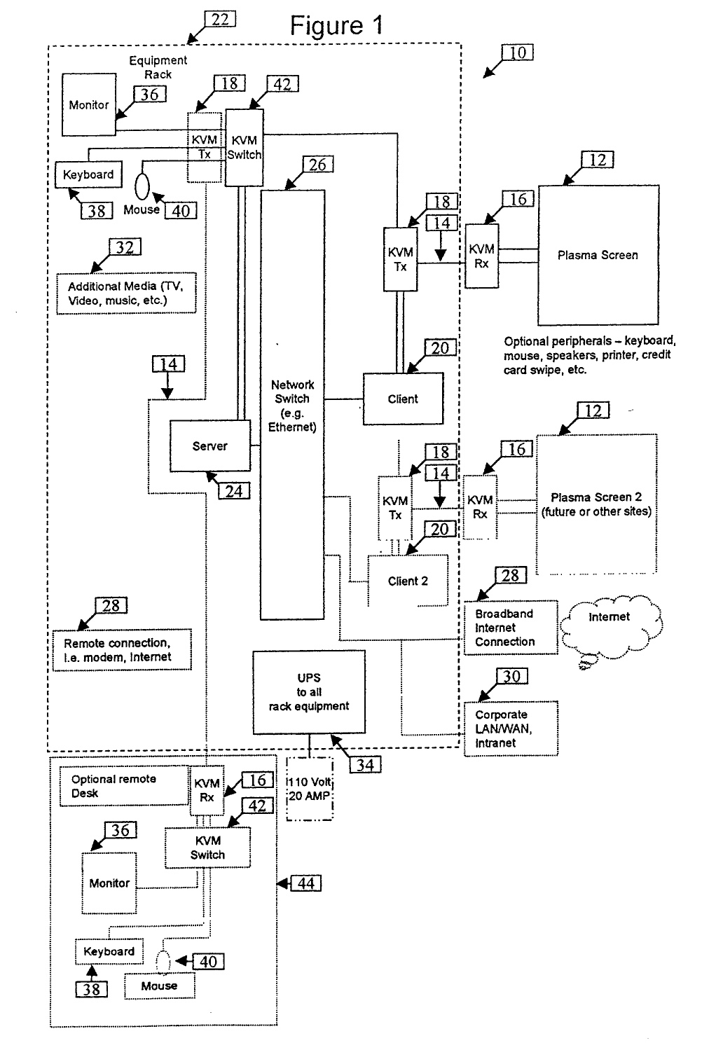

With reference to FIG. 1, the system 10 includes an interactive display screen 12 which is typically touch activated. The display screen 12 is often a flat screen with a touch interface overlay, slim wall, cabinet, desk or table mount, and having high resolution for multimedia display. The display screen 12 is preferably a plasma screen, although LCD, CRT, or other screens can be used depending upon application. Various manufacturers create overlays which convert standard monitors and screens into touch screens. Some of the more common manufacturers for plasma touch screen overlays include Smart Technologies, IST, or CarrollTouch. For LCD and CRT displays, Elo and Microtouch are the more common overlays available.

The present invention utilizes a KVM (Keyboard, Video, Mouse, Serial) extender 14 having a KVM receiver 16 coupled to the display screen 12, and a KVM transmitter 18 coupled with a client computer 20. The KVM extender includes KVM cabling, currently specified as a Category 5 data cable, but could be upgraded to Firewire, fiber optic cable, or wireless interface. The use of the KVM extender allows for extended distances between the display screen 12 and the client computer 20 which is typically situated in an equipment rack 22 several hundred feet or more from the display screen 12. This allows for a smaller footprint at the touch display screen 12, permitting a touch screen interface at display and data request and query at the equipment rack 22. It has been found that such an arrangement also allows a larger display screen 12 to be utilized that is much more esthetically pleasing and inviting to the potential user of the system 10.

The client computer 20 is connected to a server computer 24 via a computer network switch 26, such as Ethernet, Broadband Internet connection 28, or corporate LAN/WAN Intranet connection 30. Although the client computer 20 and server 24 can comprise the same machine, preferably, the client computer 20 is physically separate from the server 24 as the server is capable of storing much more information than a personal computer, and can access various databases 32, e.g. having additional media such as video, music, etc., through various network connections 26-30.

Each client computer 20 allows information services to be displayed on the touch activated display screen 12 and their retrieval from the server 24 through touch commands made at the screen 12. The client computers 20 also provide for optimized display of multimedia through the client/server system through network switch 26. The client computer 20 includes an industry standard operating system, such as Microsoft Windows, Linux, Unix, Apple Mac OS, with an industry standard web browser, such as Mosaic, Netscape Navigator or Microsoft Internet Explorer. The client computers 20 also include memory in the form of hard drive capacity, network interface components, modems, sufficient RAM, a central processing unit, and optimized video hardware/software as needed. Due to the arrangement described above, typically the client computers 20 do not include a monitor, keyboard, or mouse unless the system 10 is very simple in nature and only includes a single client computer 20 and perhaps a single interconnected server computer 24.

The server computer 24 allows for data entry, storage and retrieval, database and web page hosting, remote access by modem or internet connections and includes an industry standard operating system (such as Microsoft Windows, Linux, Unix, Apple Mac OS), web hosting services (such as Microsoft Internet Information Services or Apache), database services as required (such as Microsoft Access or SQL Server), a large hard drive capacity, network interface, modem, sufficient RAM, a central processing unit, a redundant power supply, redundant disk storage, back-up media, real-time audio and/or video capture. The server computer 24, and associated software services, host several Active Server Pages (ASP) which contain scripts of actions to perform and programmatic steps to generate Hypertext Markup Language (HTML) to be provided to the web browser. The active server pages may, or may not, contain any number of embedded scripts therein, using script languages such as Microsoft Visual Basic Script (VB Script), Microsoft's Dialect of JavaScript, or Java. The network switch 26 allows for faster data packet transfers or server information from client requests at the touch display screen 12 and typically utilizes standard TCP/IP network infrastructure and routing technology.

The equipment rack 22 preferably includes an uninterruptible power supply 34 that provides for reliability and proper shutdown of equipment at the system rack 22 in case of power failure. The uninterruptible power supply provides power to not only the client computer 20 and server 24, but also to a local workstation having a monitor 36, keyboard 38 and mouse 40 which are electrically connected to the client computer 20 and server 24 via a KVM extender 14 and KVM switches 42 which allows for visual display for operator maintenance of the database 32, server 24, network switch 26, trouble shooting of system 10 and accompanying software, as well as running diagnostics, etc. The keyboard and mouse 38 and 40 allows the operator to input text commands for maintenance and updates of the database 32, as will be described more fully herein. The KVM switch 42 allows the operator of the system 10 to switch between visual displays and select a specific client computer 20 or server 24 to work on. This saves a tremendous amount of space in the equipment rack 22 and eliminates the cost of additional monitors for each computer. Currently, such KVM switches 42 allow a user or operator to operate up to 252 different computer devices from the same monitor, keyboard and mouse workstation 36-40.

As shown in FIG. 1, a remote desk workstation 44 can be electrically connected to the equipment rack 22 using the KVM extender 14 and KVM switch 42, thus enabling an operator (e.g. a receptionist or assistant) to use his or her monitor, keyboard and mouse 36-40 to update the database and system 10 as necessary, as will be described more fully herein.

It will be noted that the system 10 of the present invention can utilize a single interactive display screen 12 and client computer 20, or multiple display screens 12 and client computers 20 connected to a single server 24. This allows multiple display screens 12 to be dispersed throughout a building or area with all display screens 12 being connected to a single equipment rack 22 some distance away and pulling information and data as needed from the single server 24. The advantages of such an arrangement will be appreciated by those skilled in the art.

The system 10 described above provides an integrated multimedia display through the combination of standard products and existing technology. As will be more fully described herein, the interactive display system of the present invention combines various features into a single system to offer an interactive display electronic access system 10. The system 10 of the present invention can be utilized in many applications including consumer inventory and/or information browsing, car dealerships, retail stores, property management, etc., trade show booths, convention centers, hotel registration, health clubs, campus maps and buildings, museums, point of sale demonstrations or purchasing, libraries, court rooms, as a ticket window, etc.

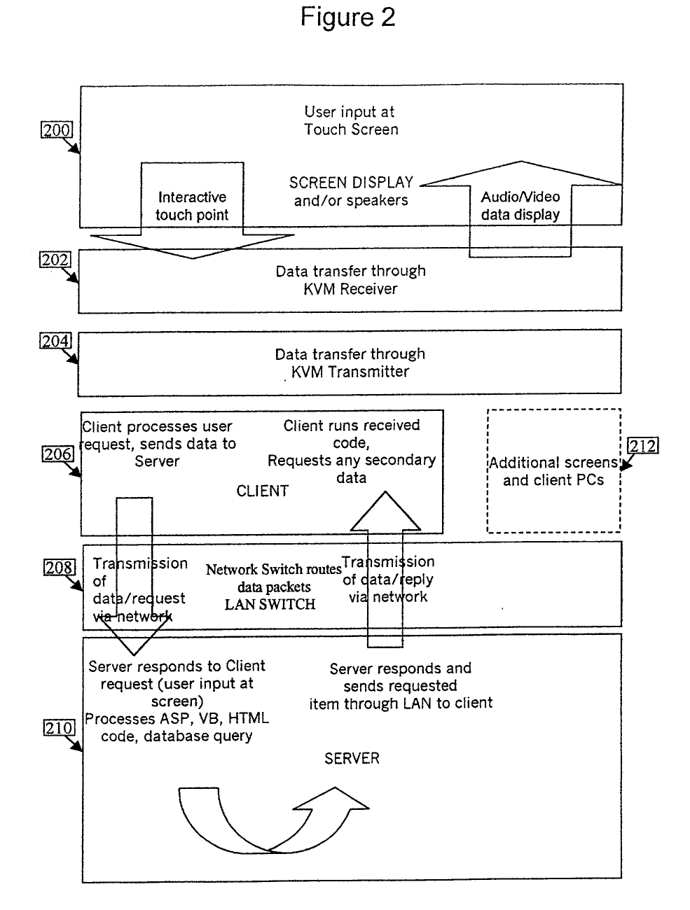

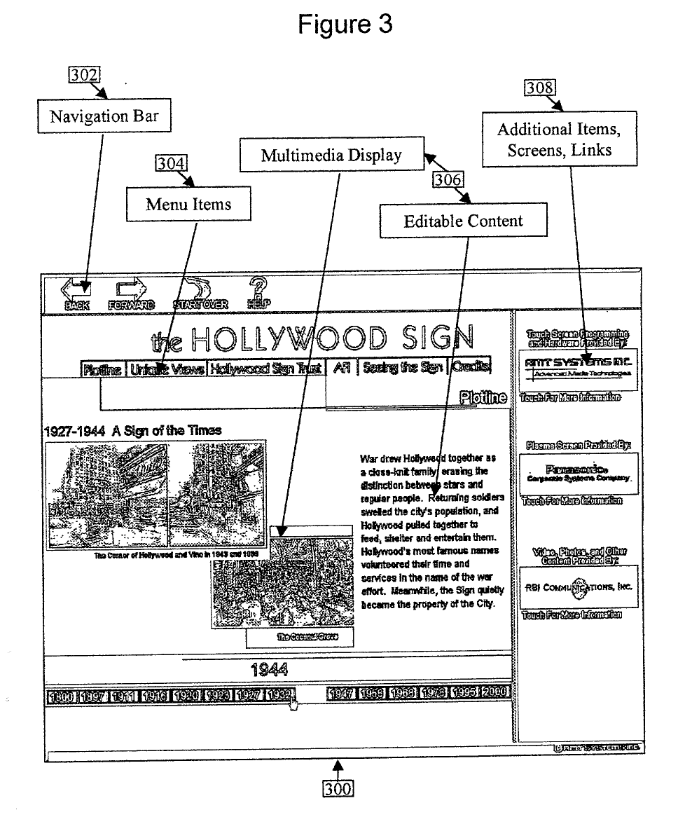

With reference now to FIG. 2, the present invention, as described above, includes a screen display 12 configured with touch overlay. The display screen 12 may also include speakers for audio playback. The user requests information by inputting a command at the display screen 12. The user merely need touch the screen at an appropriate location having a hyperlink, as illustrated in FIG. 3, in order to request additional information. The software interface uses a “hidden” web browser at the front-end of the touch display screen 12 having text titles, descriptions and corresponding multimedia, i.e. sound, streaming video, photos and graphics, which are retrievable by the end-user at the display screen 12 through touch.

With reference to FIG. 3, the typical screen display 300 is shown in a web page format, and accordingly includes a navigation bar including forward and back arrows, start over button (to return to main page), help information, and optional print information. The associated software uses a “hidden” web browser. Other software programs, as described above, allows navigation of various screens by response to touch to access information regarding schedules, programs, events, maps, etc. as dictated by the previously created data in the database associated with the display screen 12. As shown in FIG. 3, a screen 300 is shown having various displayed links, including a navigation bar 302, selectable menu items 304, a multimedia display and text content 306 which may or may not include hyper-links which are activated by touch. Typically, the screen 300 also includes additional links to other screens 308 which may include information regarding the provider of the system 10, various components of the system, or menu selections outside of the currently displayed content 306.

The actual display 300 utilizes active server pages for real time update of information displayed to the end-user, as will be described more fully herein. The interactive display system 10 allows end-users to navigate various display screens 300 by touch to access information regarding schedules, programs, training, events, maps, services, products, etc. HTML or DHTML (hypertext mark-up language and dynamic hypertext mark-up language) code is typically used with the touch activated screen interface, JAVA for “mouse over” command execution, JavaScript for navigation of various screens by response to touch, MacroMedia Flash or ShockWave for graphical animation, and X and Y coordinate mapping by touch screen overlay according to the manufacturer's proprietary software driver, replicating a standard mouse input on a computer screen. The software plots the location touched on the hardware overlay of the touch-activated screen display 12 and correlates this X and Y plotted location with a link 302-308 of the displayed screen 300 to determine the proper command/data request to be transmitted.

Referring back to FIG. 2, based upon the user interactive touch requests (200), data is transferred through KVM receiver (202) to KVM transmitter (204) which transfers the data to the client computer 20. Upon receiving the input device request or command from the user, the client computer 20 processes the user requests and sends a data request to the server 24 (206). This is performed through the LAN network switch 26 which transmits the data/requests via the computer network (208) to the server 24. The LAN switch is part of a common client/server computer architecture, and is responsible for routing the data packets in a timely manner between the server 24 and the respective client computers 20. Upon receiving the data request from the client computer 20, the server 24 responds to the data request and processes active server pages, HTML, visual basic (VB) scripting, Java, JavaScript, etc. code and any corresponding database queries (210). The server responds and generates file code and sends requested items or data through the network switch 26 (210 to 208) to the client computer (208 to 206). Such code and data include the dynamic information to be displayed, such as text, titles, descriptions, schedules, programs, training, events, maps, services, products, etc., with corresponding multimedia, i.e. sound, streaming video, photos and graphics. The client computer 20 processes the received code from the server computer 24 and requests any secondary code necessary to perform the functions. This information is then transmitted to the display screen 12 via the KVM transmitter and receiver (204 to 202), where the information is displayed on the screen (200) in the form of video images, audio playback through speakers, text, graphics, etc. based upon initial user requests. The user can now act on video images or other hyper-linked images or text by touching the display screen 12 to continue process of information retrieval. As described above, the same process can be used with additional screens 12 and client computers 20 (212) using a single network switch 26 and server 24.

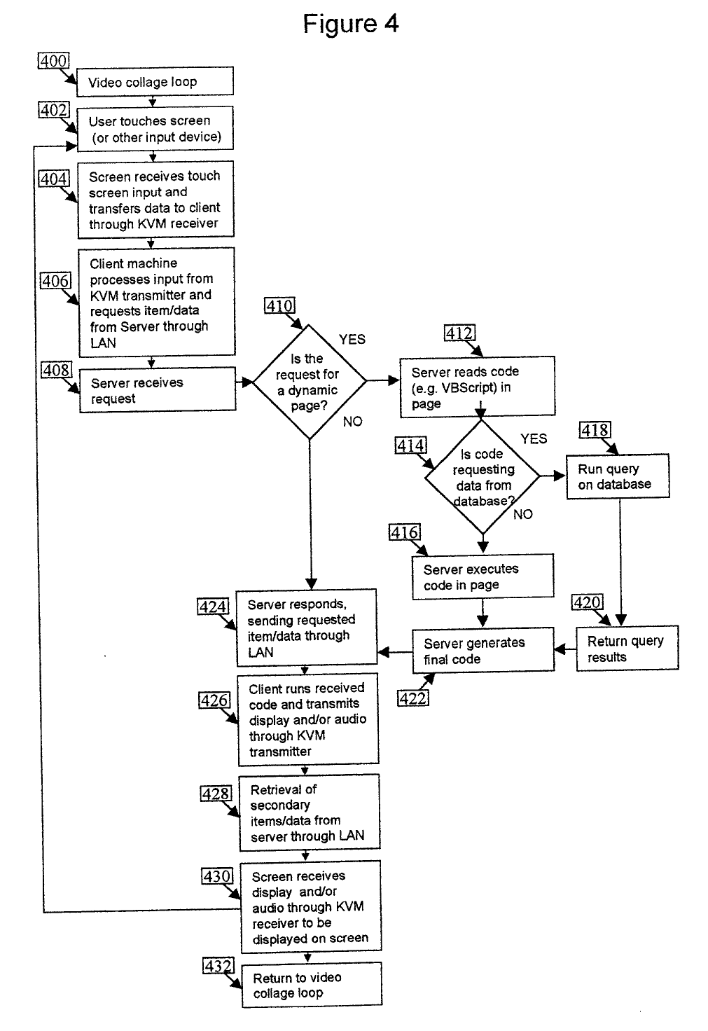

Referring now to FIG. 4, at the display screen 12, a video collage is looped (400) until the system 10 is activated by user input at the touch display screen 12 (402). Typically, the user touches the touch-activated display screen in order to activate the system, although other methods, such as by the use of a mouse, keyboard, motion detector, etc. is also possible. Upon touching the touch activated display screen 12, the location touched on the interactive screen is plotted and correlated with a display link 302-308 location, as described above, to determine the proper command. This command or data request is transmitted through the KVM extender receiver and transmitter 16 and 18 (404) to the client computer 20.

The client computer 20 processes the user request and sends the user data request to the server 24 through the LAN computer network switch (406). The system 10 uses a client/server architecture, with the server 24 hosting all data and the client requesting the data from the server 24 for the display 12. The server 24 receives the request (408) processes the primary request and determines whether the client computer requested item or data requires active formatting and/or database queries; that is, whether the link is to an active server page (ASP) (410). These include the dynamic display and formatting of information on the display such as text, titles, descriptions, schedules, programs, training, events, maps, services, products, etc., with corresponding multimedia, i.e. sound, streaming video, photos, graphics, etc. Non-dynamic, or static, pages of information are simply returned without further processing.

If the request processed by the server computer 24 is positive and requires active formatting and/or database queries, the server 24 reads and logically processes the Visual Basic (VB), JavaScript, or other code on the active server page (412). Based upon the VB script code, the server 24 processes a secondary request, that is “Does the VB code request data to be returned from the database (414)?” If the request processed by the server computer 24 is negative and does not require data from the database, such as in the case of internal matters which are not displayed on the display screen 12, the server 24 executes the remaining Visual Basic, or other, scripting code on active server pages (416). However, if the request processed by the server computer 24 is positive and requires data to be returned from the database, the server 24 runs the database search query for specified data on the database (418). Based upon the database query, the server computer 24 processes and returns database query results (420). Dynamic graphic layout software, such as Macromedia Flash Generator software may be used to extract previously generated dynamic graphic layout files for graphical layout and animation of video display. The server computer 24 generates final code based upon visual basic script on active server page and, if needed, formatted database query results (422).

The server 24 transmits the requested items or data back to the client computer 20 through the LAN network switch (424). The client computer 20 processes the received code (426) and requests any secondary data (428) and transfers the data in the form of multimedia video images, audio, text, graphics, etc. through the KVM transmitter 18 which subsequently transfers the data to the KVM receiver 16 for display at the touch activated screen (430). The user of the system 10 can now act on video images by touch to continue process of information retrieval by the same steps described above (402), or the display returns to the video collage loop after a predefined period of inactivity at the display screen 12 (432).

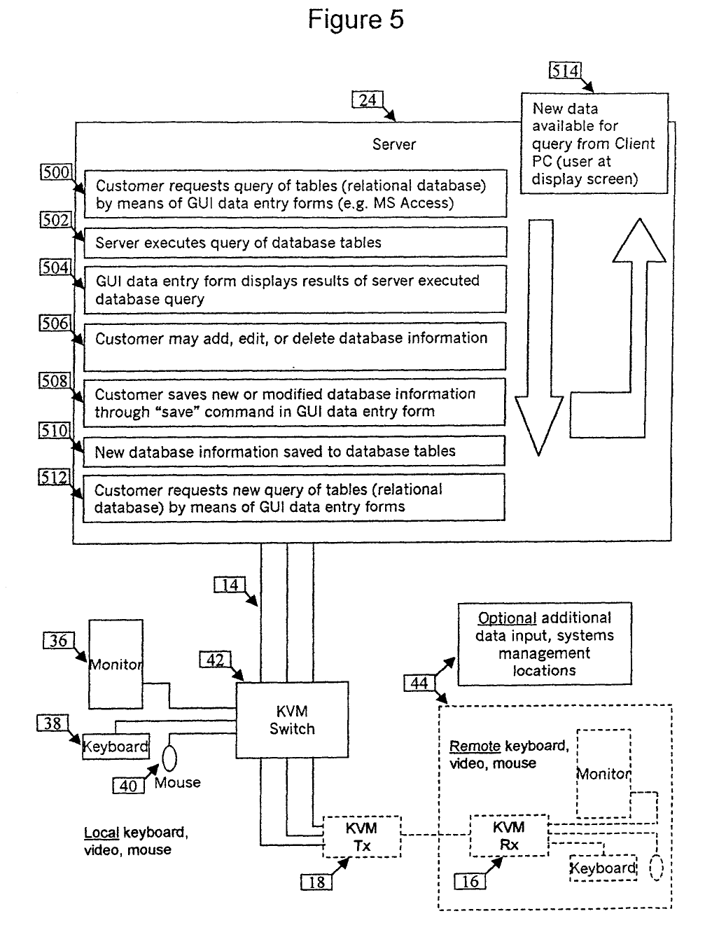

Referring now to FIG. 5, a flow diagram is illustrated depicting the steps taken in modifying previously created data files. All customer-defined and real-time editable features are stored in the database or ASP/HTML pages on the server computer 24. Preferably, the database is created using “relational” databases, which provide a “one to many”, and a “many to many” relationship between records or files stored in the various fields in customized database tables or forms. All database structures are unique and proprietary to the owner of the system 10, however all utilize existing standard software, e.g. Microsoft Access, Microsoft SQL Server, Oracle, etc. The server 24 is accessed using the workstation monitor 36, keyboard 38, mouse 40, or remote workstation 44 via KVM extenders and switch 14-18 and 42. The customer/owner uses the keyboard and mouse 38 and 40 to request query of relational database tables by means of a graphic user interface (GUI) data entry form (e.g. Microsoft Access, Microsoft Visual Basic, etc.) (500). The server 24 executes the query of database tables (502), and displays results of the server executed database query by presenting a GUI data entry form (504) at the appropriate monitor 36.

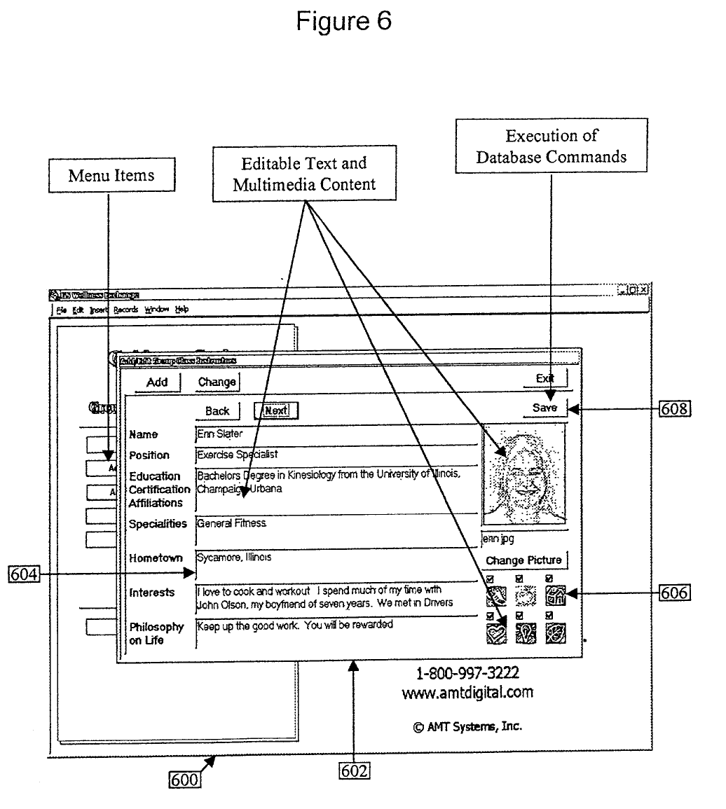

An example of a table 600, having menu items for the proper request query, and an example data entry form 602 are illustrated in FIG. 6. The entry form 602 includes editable text, typically in a template-based format, and icons for selecting multimedia content, including photographs, videos, other graphics, etc. The GUI menu is intuitive and follows a similar hierarchy to the display screen structure. For customer simplicity, the GUI utilizes selection arrows, check boxes, radio buttons, dialog boxes, and mouse and/or keyboard commands 608. The GUI interface allows a non-technical operator of the system 10 to readily modify information by highlighting and deleting, clicking on “add”, “change”, “back”, “next”, “save”, “exit”, etc. buttons 608. The customer may thus add, edit or delete records or information from the database as the need arises. For example, in a display system used in a health spa or gym, changes may be made to any of the text titles, descriptions, class schedules, class descriptions, instructor information, on site service and program information, events, corresponding multimedia, i.e. sound, streamed video, photos and graphics, retrieved by end-users of the health spa at the touch screen display 12. Due to the intuitive GUI format, this can be updated in real time without requiring knowledge of programming code or familiarity with other software.

After the customer adds, edits, deletes, and otherwise modifies the information in the database (506), this newer modified database information is saved through a “save” command, such as by clicking the “save” button, in the GUI data entry form (508). The new database information is then saved to database tables (510) whereupon the customer may request new queries of tables and new GUI data entry forms (512). At the end of the modification session, the new and modified data is available for query from the client computer (514) as the modified data is now within the database for retrieval.

Thus, the customer can make changes “at will” to the data for display without requiring technical knowledge. The use of the KVM extender 14 and switch 42 allows such changes to be made not only at the equipment rack 22, but also at remote workstations 44, enabling a receptionist, for example, to make the necessary changes in real time from his or her workstation 44.

As will be appreciated by those skilled in the art, the present invention provides many advantages. The touch activated display screen 12 occupies very little floor space and it is appealing to end-users as it is esthetically pleasing and simple to operate, requiring only the touch of a finger to navigate. On the back-end of the system 10, text entry, real time updates, etc. are easy to perform by non-technical personnel. Due to the fact that the system 10 utilizes off-the-shelf common components, support and serviceability is easy and relatively inexpensive. Also, such components integrate well with existing network infrastructure and allow for cross platform use. The familiar web page interfaces at both the front-end and back-end make the system 10 very user friendly. The display pages and forms are specifically custom-designed to meet the needs of the customer, but then the customer and operator are able to easily and quickly add, delete, and change the information for real-time display.

Although an embodiment has been described in detail for purposes of illustration, various modifications may be made without departing from the scope and spirit of the invention. Accordingly, the invention is not to be limited, except as by the appended claims.

What is claimed is:

1. A method for providing information via an interactive display system, comprising the steps of:
creating data and saving the data in a database;
inputting a command by touching an interactive display screen associated with the database;
transmitting the command to a remote client computer via a KVM extender having a receiver coupled to the interactive touch screen and a transmitter coupled to the client computer;
creating a data request and searching the database for data corresponding to the data request;
transmitting the data corresponding to the data request from the client computer to the interactive display screen via the KVM extender; and
displaying the data on the interactive screen display.

2. The method of claim 1, wherein the creating step includes the steps of using the client computer to process the input command and generate and send a data request to a server computer associated with the database via a computer network.

3. The method of claim 2, including the step of transmitting the data corresponding to the data request from the server computer to the client computer through the computer network.

4. The method of claim 1, including the step of determining the command by plotting the location touched on the interactive display screen and correlating this location with a displayed link.

5. The method of claim 2, including the step of modifying the created data using a customized database form accessed through the server computer and saving the newly generated data in the database.

6. The method of claim 5, wherein the modifying step occurs at a computer that is remotely located with respect to the client and server computers and database using a single monitor, a KVM switch, and a KVM extender.

7. The method of claim 1, including the step of determining if the requested data is dynamic.

8. The method of claim 7, including the step of formatting and compiling the dynamic data before transmitting the data to the interactive display screen.

9. The method of claim 7, wherein the formatting and compiling steps are performed using template-based dynamic web pages.

10. The method of claim 7, wherein the dynamic data comprises multimedia including graphics, animation, video, picture, or audio.

11. The method of claim 8, including the step of determining if a graphic layout is dynamic and incorporating previously created dynamic multimedia and graphic files for the dynamic graphic layout.

12. The method of claim 1, including the step of displaying the data on the interactive display screen in a web page format.

13. The method of claim 1, including the step of interfacing multiple interactive display screens and client computers with a single server computer.

14. The method of claim 1, including the step of displaying a video collage on the interactive display screen inviting activation of the system.

15. The method of claim 14, including the step of redisplaying the video collage after a predefined period of interactive display screen inactivity.

16. A method for providing information via an interactive display system, comprising the steps of:
creating data saving the data in a database;
inputting a command by touching an interactive display screen associated with the database;
transmitting the command to a remote client computer via a KVM extender having a receiver coupled to the interactive touch screen and a transmitter coupled to the client computer;
using the client computer to process the input command and generate and send a data request to a server computer associated with the database via a computer network;
determining if the data requested is dynamic;
searching the database for data corresponding to the data request;
compiling and formatting dynamic data into a template-based dynamic web page;
determining if a graphic layout is dynamic and incorporating previously created dynamic multimedia and graphic files into the dynamic graphic layout;
transmitting the data corresponding to the data request from the client computer to the interactive display screen via the KVM extender; and
displaying the data on the interactive screen display in a web page format.

17. The method of claim 16, including the step of determining the command by plotting the location touched on the interactive display screen and correlating this location with a displayed link.

18. The method of claim 16, including the step of modifying the created data using a customized database form accessed through the server computer and saving the newly generated data in the database.

19. The method of claim 18, wherein the modifying step occurs at a computer that is remotely located with respect to the client and server computers and database using a single monitor, a KVM switch, and a KVM extender.

20. The method of claim 16, wherein the dynamic data comprises multimedia including graphics, animation, video, picture, or audio.

21. The method of claim 16, including the step of interfacing multiple interactive display screens and client computers with a single server computer.

22. The method of claim 16, including the step of displaying a video collage on the interactive display screen inviting activation of the system.

23. The method of claim 22, including the step of redisplaying the video collage after a predefined period of interactive display screen inactivity.

24. A method for providing information via an interactive display system, comprising the steps of:
creating data and saving the data in a database;
modifying created data using a customized database form accessed through a server computer and saving the newly generated data in the database;
displaying a video collage on the interactive display screen inviting activation of the system;
inputting a command by touching an interactive display screen associated with the database;
determining the command by plotting the location touched on the interactive display screen and correlating this location with a displayed link;
transmitting the command to a remote client computer via a KVM extender having a receiver coupled to the interactive touch screen and a transmitter coupled to the client computer;
using the client computer to process the input command and generate and send a data request to the server computer associated with the database via a computer network;
determining if the data requested is dynamic and comprises multimedia including graphics, animation, video, picture, or audio;
searching the database for data corresponding to the data request;
compiling and formatting dynamic data into a template-based dynamic web page;
determining if a graphic layout is dynamic and incorporating previously created dynamic multimedia and graphic files into the dynamic graphic layout;
transmitting the data corresponding to the data request from the client computer to the interactive display screen via the KVM extender;
displaying the data on the interactive screen display in a web page format; and
redisplaying the video collage after a predefined period of interactive display screen activity.

25. The method of claim 24, wherein the modifying step occurs at a computer that is remotely located with respect to the client and server computers and database using a single monitor, a KVM switch, and a KVM extender.

26. The method of claim 24, including the step of interfacing multiple interactive display screens and client computers with a single server computer.
